(19) United States
(12) Patent Application Publication
(10) Pub. No.: US 2023/0400286 A1
(43) Pub. Date: Dec. 14, 2023

(54) METHOD AND SYSTEM FOR MAKING BIO-CARBON PROJECTILES

(71) Applicant: LEAR GLOBAL MUNITIONS LTD., Spruce Grove (CA)

(72) Inventor: Talby McKay, Spruce Grove (CA)

(73) Assignee: LEAR GLOBAL MUNITIONS LTD., Spruce Grove (CA)

(21) Appl. No.: 17/463,085

(22) Filed: Aug. 31, 2021

Related U.S. Application Data
(60) Provisional application No. 63/072,341, filed on Aug. 31, 2020.

(51) Int. Cl. F42B 33/00; F42B 12/72

(52) U.S. Cl. CPC F42B 33/00; C04B 35/528; F42B 12/72

(57) ABSTRACT

A method and system are presented for producing ballistic projectiles from bio-carbon by heating the bio-carbon prior to pressing the bio-carbon into a die to form the projectile. If fired from a munitions cartridge to land on the ground or in water, the bio-carbon projectile can break down and decompose to provide environmental benefits to the land or water.

### CROSS-REFERENCE TO RELATED APPLICATIONS

This application claims priority of U.S. provisional patent application Ser. No. 63/072,341 filed Aug. 31, 2020, which is incorporated by reference into this application in its entirety.

### TECHNICAL FIELD

The present disclosure is related to the field of methods and systems for producing projectiles for munitions, in particular, projectiles made of bio-carbon.

### BACKGROUND

Conventional firearm munitions comprise projectiles, or bullets, typically made of metal. Typically, bullets are made of lead where the projectile is made completely of lead or can be jacketed with another metal or metal alloy. Projectiles that are fired from firearms which do not strike an object or target will eventually fall to the ground and remain there. This can cause an environmental hazard as the lead projectile will not decompose and can contaminate the environment.

It is, therefore, desirable to provide a projectile for munitions that can break down and decompose if left in the outside environment.

### SUMMARY

A method a system for producing a bio-degradable munitions projectile is provided. In some embodiments, a munitions projectile can be formed by heating carbon sourced from one or more of bio-carbon, biochar and carbon black and then pressing the heated carbon under pressures greater than 100,000 pounds per square inch in a die to form the projectile. In some embodiments, the bio-carbon projectile can then be placed in a cartridge to form a munitions round for use in a firearm.

Broadly stated, in some embodiments, a method can be provided for making a projectile for a munition cartridge, the method comprising; processing raw bio-carbon into powdered bio-carbon; heating the powdered bio-carbon; and pressing the heated powdered bio-carbon into the projectile.

Broadly stated, in some embodiments, a projectile can be provided for a munition cartridge, the projectile made by a method comprising: processing raw bio-carbon into powdered bio-carbon; heating the powdered bio-carbon; and pressing the heated powdered bio-carbon into the projectile.

Broadly stated, in some embodiments, the method can further comprise passing the raw bio-carbon through a roller mill to produce the powdered bio-carbon.

Broadly stated, in some embodiments, the method can further comprise screening the powdered bio-carbon.

Broadly stated, in some embodiments, the method can further comprise screening the powdered bio-carbon to a size of 70 mesh.

Broadly stated, in some embodiments, the method can further comprise heating the powdered bio-carbon to at least 500° Celsius.

Broadly stated, in some embodiments, the method can further comprise tumbling the powdered bio-carbon as the powdered bio-carbon is being heated.

Broadly stated, in some embodiments, the method can further comprise pressing the heated powdered bio-carbon in a projectile die.

Broadly stated, in some embodiments, the method can further comprise pressing the heated powdered bio-carbon at a pressure of at least 100,000 pounds per square inch.

Broadly stated, in some embodiments, a system can be provided for making a projectile for a munition cartridge, the system comprising: a roller mill configured for processing raw bio-carbon into powdered bio-carbon as it passes therethrough; a heater configured for heating the roller mill whereby the powdered bio-carbon is heated as it passes through the roller mill; and a press configured for pressing the heated powdered bio-carbon into the projectile.

Broadly stated, in some embodiments, the system can further comprise a screen configured for screening the powdered bio-carbon.

Broadly stated, in some embodiments, the screen can be configured for screening the powdered bio-carbon to a size of 70 mesh.

Broadly stated, in some embodiments, the heater can be configured for heating the powdered bio-carbon to at least 500° Celsius.

Broadly stated, in some embodiments, the system can further comprise a tumbler configured for tumbling the powdered bio-carbon as it is being heated.

Broadly stated, in some embodiments, the press can be configured for pressing the heated powdered bio-carbon in a projectile die at a pressure of at least 100,000 pounds per square inch.

### BRIEF DESCRIPTION OF THE DRAWINGS

FIG. 1 is a perspective depicting bio-carbon for use in making a projectile, the bio-carbon shown in various sizes prior to be being used to make a projectile.

FIG. 2 is a flowchart depicting one embodiment of process of making a projectile using bio-carbon.

FIG. 3 is a perspective view depicting one embodiment of a heat roller for use in making a projectile out of bio-carbon.

FIG. 4 is a perspective view depicting one embodiment of a press for use in making a projectile out of bio-carbon.

FIG. 5 is a perspective view depicting embodiments of munitions cartridges with bio-carbon projectiles.

FIG. 6 is a side cross-section view depicting a munitions cartridge round with a bio-carbon projectile.

### DETAILED DESCRIPTION OF EMBODIMENTS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment can also be included in other embodiments, but is not necessarily included. Thus, the present technology can include a variety of combinations and/or integrations of the embodiments described herein.

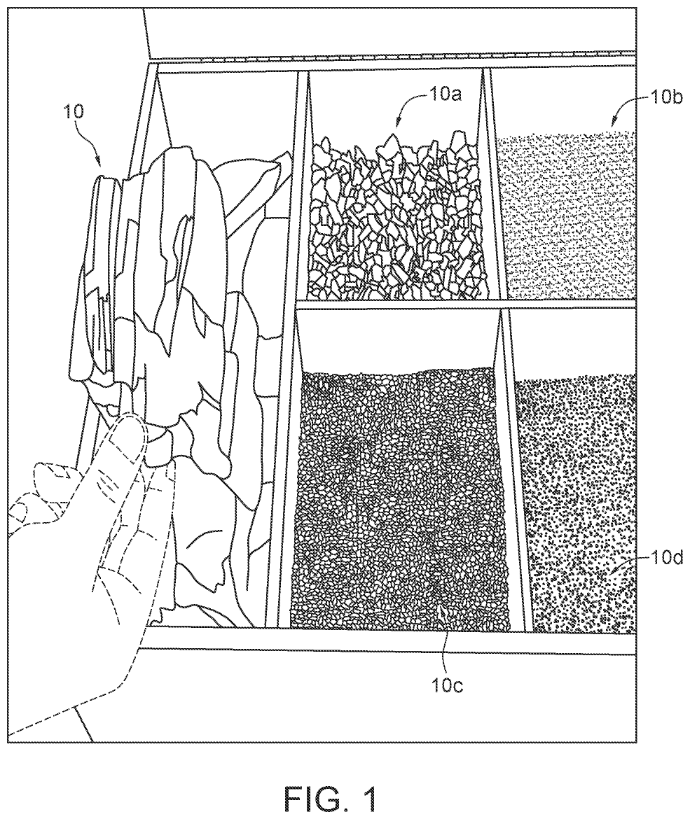

Referring to FIG. 1, some embodiments of bio-carbon 10 is shown in its raw form. In some embodiments, large pieces of bio-carbon 10 can be broken into smaller sizes and into powder form, as shown as reference characters 10a, 10b, 10c and 10d. For the purposes of this disclosure and the claims that follow, the term “bio-carbon” includes bio-carbon, biochar and carbon black as well known to those skilled in the art.

In some embodiments, the bio-carbon powder can be sourced from Northern Bio-carbon Processing Ltd. of Parksville, British Columbia, Canada or from any other CFIA, OMRI or USDA approved producer. In some embodiments, bio-carbon 10 can in the form of a powder either obtained in the desired powder form or can be milled down to powder form. In some embodiments, the bio-carbon powder can be screened to a size of 70 mesh for making projectiles. Bio-carbon can be a high-carbon, fine-grained residue that is produced through modern pyrolysis processes. It can be the direct thermal decomposition of biomass in the absence of oxygen (preventing combustion). The use bio-carbon offers several benefits for soil health. Many benefits are related to the extremely porous nature of the processed bio-carbon, which can be effective at retaining both water and water-soluble nutrients. In some embodiments, bio-carbon can increase soil fertility of acidic soil (low PH soils), increase agricultural productivity and provide protection against some foliar and soil-borne diseases. Bio-carbon also can, when introduced to water can, in the rawest form, attract Algae blooms, phosphorus, red tide and other toxins thereby enabling a cleansing or filtering effect on the water.

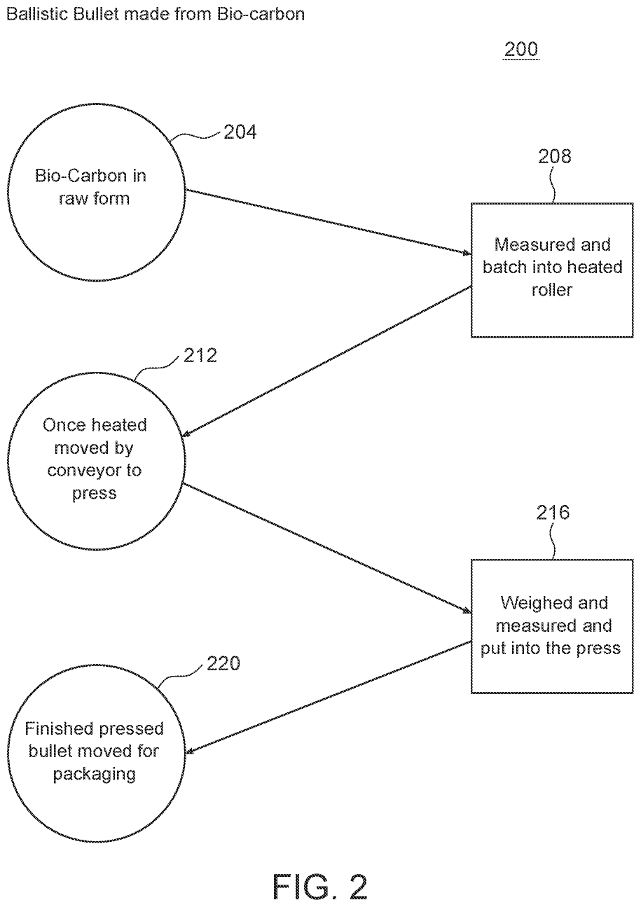

Referring to FIG. 2, a flowchart showing one embodiment for producing projectiles made of bio-carbon is shown, represented by reference character 200. In some embodiments, process 200 can comprise of the following steps. At step 204, bio-carbon in its raw form can be measured and placed onto a heated roller at step 208. In some embodiments, the bio-carbon can be heated to 500° Celsius at step 212 over a period of time to allow the bio-carbon to bond together when placed under pressure in a die at step 216 to form a projectile. In some embodiments, the bio-carbon can be expressed to pressures exceeding 100,000 pounds per square inch to the projectile in the die. After the bio-carbon has been pressed into a projectile, the projectile can be assembled into a munition cartridge at step 220.

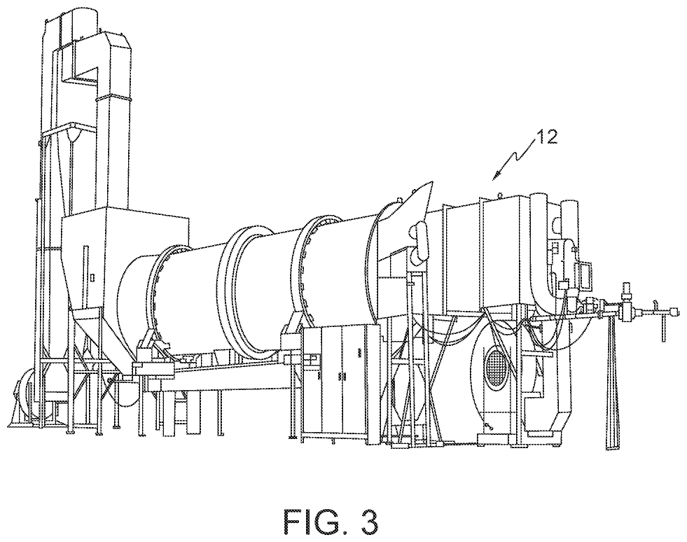

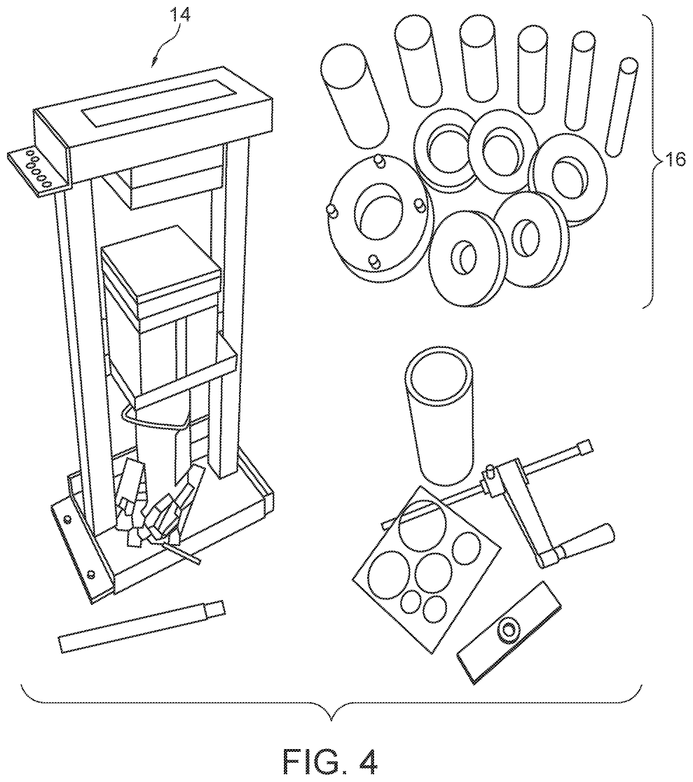

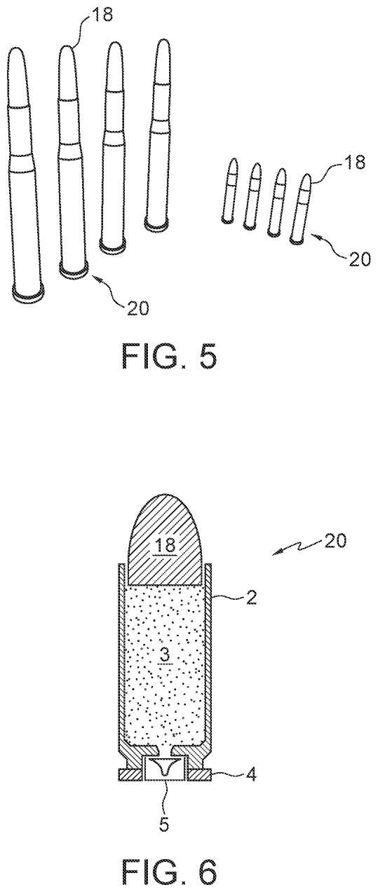

Referring to FIG. 3, one embodiment of a heat roller 12 for use to heat the bio-carbon is shown. In some embodiments, heat roller 12 can comprise a rotary drum dryer similar to those used to produce wood pellets, as well known to those skilled in the art. In some embodiments, heat roller 12 can apply the appropriate heat needed through the combustion of liquified natural gas (LNG) to increase the temperature of the raw bio-carbon. As the bio-carbon is introduced into heat roller 12 one end, the roller can be spinning in a counter-clockwise rotation with flights inside. The bio-carbon product can move slowly in a forward motion through the entire length of heat roller 12. The LNG can be distributed through heat roller 12 using a manifold system to distribute heat evenly through the length of heat roller 12. It can feed ignitors that can burn and allow the metal of the roller to heat up the entire heat roller 12. The bio-carbon product can then exit heat roller 12 at the other end at an extremely high temperature. Once the bio-carbon product leaves heated roller 12, it can travel a short distance by a zero-displacement metal conveyor to be pressed by press machine 14 using dies 16, as shown in FIG. 4, where a weighed-out portion of the bio-carbon product can then be compressed to a specific shape and density for a projectile for a particular munitions cartridge. The newly formed projectile can then be checked for quality and package for shipping. Examples of such formed munition cartridges 20 made with projectiles 18 are shown in FIG. 5.

In some embodiments, projectile 18 can be assembled into cartridge 20, that can further comprise of projectile 18 placed into casing 2 filled with propellant 3 (such as gunpowder), wherein casing 2 can comprise of rim 4 for use with a firearm extractor and of primer 5 that can ignite propellant 3 when struck with a firing pin of a firearm.

In some embodiments, a projectile made from bio-carbon as described herein can be considered to be a green technology as it is environmentally friendly in that a bio-carbon projectile can enhance soils and promote growth as it decomposes after having been fired on land. When fired into rivers, lakes, oceans and other waterways, bio-carbon projectiles, as they break down and decompose, can aid in the filtering of toxins and help control algae growths in the water and even attract heavy metals and remove them from the water.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. A method for making a projectile for a munition cartridge, the method comprising:
a) processing raw bio-carbon into powdered bio-carbon;
b) heating the powdered bio-carbon; and
c) pressing the heated powdered bio-carbon into the projectile.

2. The method as set forth in claim 1, further comprising:
a) passing the raw bio-carbon through a roller mill to produce the powdered bio-carbon; and
b) screening the powdered bio-carbon.

3. The method as set forth in claim 2, further comprising screening the powdered bio-carbon to a size of 70 mesh.

4. The method as set forth in claim 1, further comprising heating the powdered bio-carbon to at least 500° Celsius.

5. The method as set forth in claim 1, further comprising tumbling the powdered bio-carbon as the powdered bio-carbon is being heated.

6. The method as set forth in claim 1, further comprising pressing the heated powdered bio-carbon in a projectile die.

7. The method as set forth in claim 6, further comprising pressing the heated powdered bio-carbon at a pressure of at least 100,000 pounds per square inch.

8. A projectile for a munition cartridge, the projectile made by a method comprising:
a) processing raw bio-carbon into powdered bio-carbon;
b) heating the powdered bio-carbon; and
c) pressing the heated powdered bio-carbon into the projectile.

9. The projectile as set forth in claim 8, wherein the method further comprises:
a) passing the raw bio-carbon through a roller mill to produce the powdered bio-carbon; and
b) screening the powdered bio-carbon.

10. The projectile as set forth in claim 9, wherein the method further comprises screening the powdered bio-carbon to a size of 70 mesh.

11. The projectile as set forth in claim 8, wherein the method further comprises heating the powdered bio-carbon to at least 500° Celsius.

12. The projectile as set forth in claim 8, wherein the method further comprises tumbling the powdered bio-carbon as the powdered bio-carbon is being heated.

13. The projectile as set forth in claim 8, wherein the method further comprises pressing the heated powdered bio-carbon in a projectile die.

14. The projectile as set forth in claim 13, wherein the method further comprises pressing the heated powdered bio-carbon at a pressure of at least 100,000 pounds per square inch.

15. A system for making a projectile for a munition cartridge, the system comprising:
a) a roller mill configured for processing raw bio-carbon into powdered bio-carbon as it passes therethrough;
b) a heater configured for heating the roller mill whereby the powdered bio-carbon is heated as it passes through the roller mill; and
c) a press configured for pressing the heated powdered bio-carbon into the projectile.

16. The system as set forth in claim 15, further comprising a screen configured for screening the powdered bio-carbon.

17. The system as set forth in claim 16, wherein the screen is configured for screening the powdered bio-carbon to a size of 70 mesh.

18. The system as set forth in claim 15, wherein the heater is configured for heating the powdered bio-carbon to at least 500° Celsius.

19. The system as set forth in claim 18, further comprising a tumbler configured for tumbling the powdered bio-carbon as it is being heated.

20. The system as set forth in claim 15, wherein the press is configured for pressing the heated powdered bio-carbon in a projectile die at a pressure of at least 100,000 pounds per square inch.
